(19) United States
(12) Patent Application Publication
(10) Pub. No.: US 2004/0225035 A1
(43) Pub. Date: Nov. 11, 2004

(54) Cellulose ether blends of increased bulk density, their use in construction material systems, and a process for producing cellulose ether blends of increased bulk density

(76) Inventors: Hartwig Schlesiger, Bad Fallingbostel (DE); Erik-Andreas Klohr, Walsrode (DE); Wolfgang Dannhorn, Soltau (DE); Hans-Jurgen Juhl, Bad Fallingbostel (DE); Arne-Henning Kull, Bomlitz (DE); Gunter Weber, Krefeld (DE); Peter Wolbers, Walsrode (DE)

Correspondence Address: BAYER MATERIAL SCIENCE LLC, 100 BAYER ROAD, PITTSBURGH, PA, 15205, US

(21) Appl. No.: 10/768,765

(22) Filed: Jan. 30, 2004

(30) Foreign Application Priority Data
Feb. 6, 2003 (DE) 10304816.2

(51) Int. Cl. C08L 1/26; C08L 3/00

(52) U.S. Cl. 524/42; 524/43; 524/50; 525/54.31

(57) ABSTRACT

The present invention encompasses cellulose ether blends comprising

a) cellulose ether,

b) from 0.1 to 10% by weight of an additive selected from starch, starch ether, guar, guar ether and xanthan, based on the dry cellulose ether,

c) optionally from 0.05 to 1% by weight of polyacrylamide, based on the dry cellulose ether, and

d) optionally further additives,

characterized in that additive b) has been metered in as an aqueous solution or as a powder and polyacrylamide c) has been metered in as an aqueous solution to a water-moist cellulose ether having a moisture content in the range from 25% to 75% by weight, based on the weight of the moist cellulose ether, with mixing and optionally further addition of water, and processes for making and using the blends.

### BACKGROUND OF THE INVENTION

1. Field of the Invention

The present invention relates to cellulose ether blends of increased bulk density, their use in construction material systems, and a process for increasing the bulk density of cellulose ethers.

2. Brief Description of the Prior Art

In view of their outstanding properties cellulose ethers find diverse application, for example as thickeners, adhesives, binders, dispersants, water retention agents, protective colloids, stabilizers, suspending agents, emulsifiers and film formers.

While methods for preparing cellulose ethers are known, they are disadvantaged in that they fail to impart desirable properties such as increased bulk density. Generally, cellulose ethers are prepared by alkaline digestion of cellulose and subsequent etherification with etherifying reagents such as methyl chloride, ethylene oxide and propylene oxide. After the resulting crude cellulose derivatives have been washed, compacted, milled and dried, a product suitable for industrial applications is produced. The disadvantage of this process is that the compaction, milling and drying of cellulose derivatives, in particular, involves considerable use of apparatus, which requires high capital investment.

At any rate, the likes of methylhydroxyethyl celluloses and methylhydroxypropyl celluloses and methyl celluloses, and derivatives of these products, are in some cases impossible, or very difficult, to bring to the finenesses and bulk density required for the application. This is all the more so when the products in question have a high degree of methylation and/or a low degree of hydroxyalkylation.

High bulk densities are required in cellulose ethers for reasons including the assurance of ease of incorporation into cementitous systems or plaster systems by mixing. An increased bulk density also offers advantages associated with packaging and transportation, since for a given mass the volume which has to be transported is less.

In this regard, it has long been known that the combination of cellulose ethers with other additives or adjuvants makes it possible to set specific properties in formulations for technical applications.

U.S. Pat. No. 4,654,085 describes a multicomponent additive whose components include starch ethers and polyacrylamides. The proportion is advantageously specified as follows: 95-75:20-5:1 cellulose ether to starch ether to polyacrylamide.

In U.S. Pat. No. 4,654,085 the additives are mixed in powder form into the cellulose ether, which is likewise present in powder form, so that the bulk density and fineness of the cellulose ether are unaffected.

DE-A 10 041 311 describes a process for modifying cellulose ethers which is characterized in that a moist cellulose ether is mixed with an additive or mixture of additives in the form of an aqueous or organic suspension, after which the resulting mixture is dried.

In DE-A 10041311 the additives are not incorporated in powder form, and no starch ethers are used either.

EP-A 1 127 910 and EP-A 1 127 895 describe processes for the combined milling/drying of cellulose derivatives. Both applications describe the possibility of adding starch ether additives, to the milled material prior to combined milling/drying. However, neither EP-A 1 127 910 nor EP-A 1 127 895 gives any indication as to what quantities are advantageous, how the addition of additives is to take place, and which starch ethers can be used with advantage.

As would be gathered from the foregoing, there is a need for providing cellulose ethers having improved properties and processes for preparing them. Therefore, it was an object of the present invention to provide cellulose ether blends of increased bulk density and also a process that makes it possible in a simple way to increase the bulk density of cellulose ethers, while at the same time also, where appropriate, influencing the fineness of the powder towards finer products.

### SUMMARY OF THE INVENTION

This object has been achieved by mixing water-moist cellulose ethers, such as are present, for example, after the washing of crude cellulose ethers, with starch ethers and, with addition of water and with mixing, bringing the resultant mixture to a moisture content which is ideal for the subsequent operating steps. Where appropriate it is possible to produce a synergistic effect of ______ by adding polyacrylamide additives as well. The amount of starch ether used is from 0.1 to 10% by weight, based on the dry cellulose ether, and the amount of the polyacrylamide, where used, is from 0.05 to 1.0% by weight, based on the dry cellulose ether. The starch ether is added here in the form of an aqueous solution or, preferably, in the form of powder, while the polyacrylamide is metered in as an aqueous solution. The cellulose ethers thus treated with additives are subsequently dried and milled, sequentially or in one step.

The invention accordingly provides cellulose ether blends comprising:

a) cellulose ether,

b) from 0.1 to 10% by weight of an additive selected from starch, starch ether, guar, guar ether and xanthan, based on the dry cellulose ether,

c) optionally from 0.05 to 1% by weight of polyacrylamide, based on the dry cellulose ether, and

d) optionally further additives,

characterized in that additive b) has been metered in as an aqueous solution or, preferably, as a powder, and polyacrylamide c) has been metered in as an aqueous solution to produce a water-moist cellulose ether having a moisture content in the range from 25% to 75% by weight, based on the weight of the moisture cellulose ether, with mixing and optionally further addition of water.

Such blends of the invention surprisingly exhibit a distinctly increased bulk density and where appropriate a distinctly increased fineness as compared with products which have not been treated with starch ether additives and optionally with polyacrylamide additives.

In the present invention it has now surprisingly been found that, when starch ethers and, if desired, polyacrylamides are incorporated into the moist cellulose ether, the bulk density and possibly the fineness of the products are influenced positively. In order to achieve advantageous properties it is possible to further mix additional powder-form additives, (as described for example in U.S. Pat. No. 4,654,085), with the amounts of starch ether and polyacrylamide already incorporated into the moist cellulose ether, into the cellulose ether which has already been treated with additives, so as to form a multi-component additive, it being possible to take account of the amounts of starch ether and polyacrylamide already incorporated into the moist cellulose ether with regard to the amount to be employed.

In accordance with the process of the invention water-moist cellulose ethers, as present, for example, after the washing of crude cellulose ethers, are mixed with starch ethers and brought to a moisture content which is ideal for the following operating steps, where appropriate with further addition of water and with mixing.

Cellulose derivatives employed here are preferably methyl cellulose derivatives, more preferably methyl cellulose or methylhydroxyalkyl cellulose. The most preferred methylhydroxyalkyl cellulose used is methylhydroxyethyl cellulose or methylhydroxypropyl cellulose.

In the case of the methylhydroxyalkyl celluloses the DS (methyl) is from 0.9 to 3 and the MS (hydroxyalkyl) is from 0.05 to 4. Preferably the DS (methyl) is from 1.4 to 2.3 and the MS (hydroxyalkyl) is from 0.05 to 1.0. Most preferably the DS (methyl) is from 1.7 to 2.0 and the MS (hydroxyalkyl) is from 0.1 to 0.2. Use is made in particular of methylhydroxyethyl celluloses.

In the case of methyl cellulose the DS (methyl) is preferably from 1.4 to 2.3. Most preferably the DS (methyl) is from 1.7 to 2.0. DS is the average number of substituted OH groups per anhydroglucose unit, denoting alkyl substitution. Methyl substitution, for example, is specified as DS (methyl) or DS (M).

The hydroxyalkyl substitution is normally described by the MS. The MS is the average number of moles of the etherifying reagent attached in ether form per mole of anhydroglucose unit. Etherification with the etherifying reagent ethylene oxide, for example, is specified as MS (hydroxyethyl) or MS (HE). Etherification with the etherifying reagent propylene oxide, accordingly, is specified as MS (hydroxypropyl) or MS (HP).

In the preparation, following washing and filtration, the water-moist filter cakes have a moisture content of 25 to 75% by weight, based on the weight of the moist cellulose ether. It is preferred to use those water-moist filter cakes which possess a moisture content of from 45 to 65% by weight. They are mixed with an aqueous starch ether solution or, preferably, with the dry starch ether powder. If desired water can be further metered in during this mixing operation or subsequently, with mixing, in order to adjust the moisture content of the granules of the blend. The additional water is preferably added after the starch ether has been mixed in.

The moisture content of the blend produced in this way (granule moisture content) is usually from 45 to 80% by weight based on the overall weight of the blend, preferably from 60 to 75% by weight and more preferably from 65 to 75% by weight.

As additive b) it is preferred to use a starch ether.

Starch ethers employed in this context are hydroxyalkyl starches, though the use of alkylhydroxyalkyl starches or carboxymethylhydroxyalkyl starches is also possible. Preference is given to hydroxyalkyl starches such as hydroxymethyl, hydroxyethyl or hydroxypropyl starch, for example, those having an MS (hydroxyalkyl) of from 0.3 to 0.9, more preferably hydroxyalkyl starches having an MS (hydroxyalkyl) of from 0.4 to 0.6. Of the hydroxyalkyl starch, particular preference is given to hydroxypropyl starch.

Starch ethers of this kind are prepared by reacting starch with etherifying reagents in the present of alkaline catalysts. In order to raise the viscosity of the resulting starch ether it is possible in this case to use bifunctional or polyfunctional crosslinking reagents such as epichlorohydrin for example.

Preference is given to using starch ethers having a viscosity (5% strength by weight in water, 25° C., Brookfield) of more than 60 mPas. More preferably high-viscosity starch ethers, having a viscosity of more than 600 mPas are used . Most preferably high-viscosity starch ethers prepared, inter alia, by the use of crosslinking reagents are used.

The amount of starch ether used is from 0.1 to 10% by weight based on the dry cellulose ether. It is preferred to use from 0.5 to 8% by weight, it is more preferred to use from 1.0 to 5% by weight, and most preferred to use from 1.5 to 2.5% by weight. The starch ether here is added preferably in powder form, with mixing, to the water-moist cellulose ether.

Instead of the starch ether it is also possible to use starch, guar, guar derivatives such as hydroxypropyl guar or xanthan as additives to the granulating stage.

It may be possible to produce a synergistic effect by adding polyacrylamide additives in addition. The amount of the polyacrylamide, where used, is from 0.01 to 1.0% by weight, based on the dry cellulose ether. The polyacrylamide is metered in preferably in an amount from 0.1 to 0.6% by weight. The polyacrylamide is metered in as an aqueous solution before, during or after the metered addition of the starch ether. Preferably, the polyacrylamide is added after the metered addition of the starch ether. The polyacrylamide is metered in in the form of an aqueous solution in a concentration of from 0.5 to 10% by weight, based on the total weight of the aqueous solution, more preferably as an aqueous solution with a strength of from 2 to 7% by weight.

As polyacrylamide it is possible to use anionic, non-ionic or cationic polyacrylamides. Preference is given to using anionic polyacrylamides having a sodium acrylate content of less than 20% by weight and a viscosity (1% strength by weight in 10% strength by weight sodium chloride solution, 25° C. Brookfield) of less than 1000 mPas.

The addition of starch ethers raises the bulk density of the resulting products in comparison to non-inventive cellulose ethers by more than 20 g/l, preferably by more than 40 g/l, more preferably by more than 60 g/l, and most preferably by more than 80 g/l. An increase in the bulk density is achieved with small amounts of just 0.5% by weight of starch ether, based on the dry cellulose ether, while the additional increase in the fineness is achieved with the preferred amounts of from 1.0 to 5.0% by weight of starch ether. In this case the fraction passing through a 0.063 mm sieve is increased by more than 25%, preferably by more than 50%, relative to the control without the use of starch ether.

If both starch ether and polyacrylamide additives are added, the bulk density of the resulting products is raised by 20 g/l in comparison with non-inventive cellulose ethers, preferably by more than 40 g/l, more preferably by more than 60 g/l, or even in particular by more than 80 g/l. There is also a distinct increase in the fineness of the products, with the process conditions otherwise constant. This increase is manifested in an increase in the fraction of material passing through a 0.063 mm sieve. The fraction of material passing through a 0.063 mm sieve is increased by more than 50%, preferably by more than 100%, relative to the control without the use of starch ether and without the use of polyacrylamide (Example 9 to 2 or Example 10 to 1). The fraction of material passing through a 0.063 mm sieve is increased by more than 20%, preferably by more than 40%, relative to the control without the use of starch ether and with the use of polyacrylamide (Example 9 to 5 or Example l to 3).

If desired it is possible to add further additives such as, for example, glyoxal and/or buffer mixtures, in the form for example of aqueous solutions, to the water-moist cellulose ether. Dissolution-retarded products are then obtained by this means. The preparation of dissolution-retarded cellulose derivatives has long been known to the person skilled in the art.

The invention further provides a process for preparing cellulose ether blends of increased bulk density, characterized in that

a) from 0.1 to 10% by weight of an additive selected from starch, starch ether, guar, guar ether or xanthan is metered into a water-moist cellulose ether having a moisture content in the range from 25 to 75% by weight based on the total weight of the blend, the percentages by weight being based on the dry cellulose ether, in the form of an aqueous solution or, preferably, in the form of a powder,

b) if desired, from 0.01 to 1% by weight of polyacrylamide is metered in, the percentages by weight being based on the dry cellulose ether, in the form of an aqueous solution, and

c) if desired, further additives

are metered in with mixing and, where appropriate, further addition of water, after which the blend is subjected to milling and drying.

Water is added until the granules of the blend have a moisture content of from 45 to 80% by weight, preferably from 60 to 75% by weight, and very preferably from 65 to 75% by weight, based in each case on the total weight of the blend.

The cellulose ether blends are dried and milled, with milling and drying sequentially or preferably in one step. The drying and milling, or combined milling/drying, are conducted here in accordance with methods from the prior art. Where appropriate this may be followed by further milling steps in accordance with the prior art, in order to achieve a further reduction in the size of the products.

Alternatively the process conditions affecting the milling and drying or combined milling/drying can be varied so that the fineness of the products remains unchanged but the amount of energy required to reduce the size of the products is reduced.

The invention further provides for the use of the blends of the invention in construction material systems.

The blends of the invention find preferred use as additives to tile adhesives, plasters such as cement plaster or gypsum plaster, filling compounds, cementitous systems which are extruded, and other construction materials.

In order to adapt the products for use in specific construction material systems it is possible where appropriate to add further, pulverulent additives, as described for example in U.S. Pat. No. 4,654,085.

The invention is further described by way of the following illustrative but non-limiting examples.

### EXAMPLES

Combined milling/drying unit:

The combined milling/drying unit used in Examples 1 to 12 and the combined milling/drying operation can be described as follows:

The milling unit is composed of a sieveless high-speed gas flow rotary mill (450 mm diameter, 5 milling tracks, 3650 rpm). Downstream of the mill are a cyclone separator and a bag filter. Arranged on the clean gas side is a fan Which conveys the dust-free gas flow into a heat exchanger, where the transport gas is superheated to the required drying temperature.

A metering screw meters the granules into the mill at the level of the first and second milling tracks. A perforated plate upstream of the metering screw divides the supplied material into individual strands with a diameter of approximately 10 mm.

Excess transport gas is removed.

The incoming transport gas has a temperature of from 200 to 240° C. under atmospheric pressure. After the mill a temperature of the transport gas is from 120 to 130° C. The volume of gas circulated is from 1 000 to 1 200 cubic metres (measured under operating conditions) per hour (downstream of the mill).

The throughput of granules was set so as to give a throughput of approximately 18 kg dry product/h.

Measurement method: unless otherwise specified, the stated viscosities of the methylhydroxyethyl celluloses and methylhydroxypropyl celluloses were measured on 2% strength by weight of solutions of the dry cellulose ethers in water at 20° C. and a shear rate of 2.55 s⁻¹ (instrument: Haake Rotovisko VT 550)

### Examples 1 to 4

In a 300 1 ploughshare mixer from Lödige, batches of 29 kg of a moist methylhydroxyethyl cellulose (solids content 45% by weight, 22 000 mPas, DS (M) 1.8 and MS (HE) 0.1) are mixed intensely at 50-30° C. with starch ether powder (hydroxypropyl starch, MS (HP) 0.5, Brookfield viscosity 5% strength by weight in water: 1 200 mPas at 25° C., spindle 4 at 100 rpm, amount used based on dry MHEC: see Table 1) and sprayed with water such that the resulting granules have the moisture content (based on total mass) given in Table 1 (granule moisture content). The granules are subsequently comminuted and dried simultaneously in the combined milling/drying apparatus described above.

TABLE 1

| | | Granule | | Sieve through | Change in sieve | |
|---|---|---|---|---|---|---|
| | | moisture | Bulk | fraction | through | |
| | HPS | content | density | <0.063 mm | fraction | Comparative/ |
| Example | % by wt. | % by wt. | g/l | % by wt. | 0.063 mm | inventive |
| 1 | 0 | 71.5 | 170 | 32 | — | C |
| 2 | 0 | 74.5 | 165 | 29 | — | C |
| 3 | 2 | 72 | 256 | 52 | +62.5% | I |
| | | | | | relative to Ex. 1 | |
| 4 | 2 | 73.5 | 262 | 57 | +96.5% | I |
| | | | | | relative to Ex. 2 | |

Under otherwise comparable conditions the process of the invention (Examples 3 and 4) gives products having a distinctly higher bulk density and distinctly higher fine fraction in the sieve line in comparison to Examples C1 and C2 (without addition of hydroxypropyl starch).

### Examples 5 to 7

In a 300 1 ploughshare mixer from Lödige 29 kg of a moist methylhydroxyethyl cellulose (solids content 45% by weight, 22 000 mPas, DS (M) 1.8 and MS (HE) 0.1) are mixed intensely at 50-30° C. with starch ether powder (hydroxypropyl starch, MS (HP) 0.5, Brookfield viscosity 5% strength by weight in water: 1 200 mPas at 25° C., spindle 4 at 100 rpm, amount used based on dry MHEC: see Table 2) and sprayed with water such that the resulting granules have the moisture content (based on total mass) given in Table 2 (granule moisture content). The granules are comminuted and simultaneously dried (see above).

TABLE 2

| | | Granule | | Sieve through | |
|---|---|---|---|---|---|
| | HPS | moisture | Bulk | fraction | |
| | % by | content | density | <0.063 mm | Comparative/ |
| Example | wt. | % by wt. | g/l | % by wt. | inventive |
| 5 | 0.5 | 75 | 191 | 29 | I |
| 6 | 5 | 73.5 | 296 | 74 | I |
| 7 | 10 | 72.5 | 278 | 36 | I |

The process of the invention gives products having a distinctly higher bulk density relative to the comparative Examples 1 and 2 (without addition of hydroxypropyl starch) and additionally in Example 6 the fineness is distinctly increased as compared with comparative Example 2 (without addition of hydroxypropyl starch) (+155%).

### Examples 8 to 10

In a 300 1 ploughshare mixer from Lödige, 33 kg of a moist methylhydroxyethyl cellulose (solids content 43% by weight, 32 000 mPas, DS (M) 1.8 and MS (HE) 0.1) are mixed intensely at 50-30C with starch ether powder (hydroxypropyl starch, MS (HP) 0.5, Brookfield viscosity 5% strength by weight in water: 1 200 mPas at 25° C., spindle 4 at 100 rpm, amount based on dry MHEC: see Table 3) and sprayed with water, and additionally a 5% strength by weight aqueous solution of polyacrylamide (Brookfield viscosity 1% by weight in 10% strength by weight sodium chloride solution: 500 mPas at 25° C., spindle 1 at 10 rpm, approximately 10% by weight sodium acrylate in PAAm, amount used (active substance content based on dry MHEC): see Table 3) are metered in with mixing, so as to give the moisture content (based on total mass) listed in Table 3 in the resulting granules (granule moisture content). The granules are comminuted and simultaneously dried (see above).

TABLE 3

| | | | Granule | | Sieve through | Change in sieve | |
|---|---|---|---|---|---|---|---|
| | HPS | PAAm | moisture | Bulk | fraction | through | |
| | % by | % by | content | density | <0.063 mm | fraction | Comparative/ |
| Example | wt. | wt. | % by wt. | g/l | % by wt. | 0.063 mm | inventive |
| 8 | 0 | 0.3 | 73 | 174 | 51 | — | C |
| 9 | 0.5 | 0.3 | 74 | 253 | 65 | +124% | I |
| | | | | | | relative to Ex. 2 | |
| 10 | 2.0 | 0.3 | 72 | 275 | 71 | +122% | I |
| | | | | | | relative to Ex. 1 | |

Examples 9 and 10 (process according to the invention) under otherwise comparable conditions give products having a markedly higher bulk density and a markedly higher fine fraction in the sieve line. The comparative Example C8, as a result of addition of polyacrylamide additive, does give a product with a greater fineness as compared with Example 1 (without the use of polyacrylamide), but there is no substantial increase in bulk density. The examples with addition of hydroxypropyl starch and polyacrylamide additives (Examples 9 and 10), on the other hand, retain a comparable granule moisture content but exhibit a further increase in the bulk density and in the fineness as compared with the examples in which the only additive was hydroxypropyl starch (Examples 5 and 3).

### Examples 11 to 12

The procedure of Examples 8 to 10 is repeated but this time the starch ether is added as a 5% strength by weight of aqueous solution to the moist methylhydroxyethyl cellulose and mixed intensely. Water and a 5% strength by weight solution of the polyacrylamide are metered in with mixing, so as to give the granule moisture content indicated in Table 4. The granules are comminuted and simultaneously dried.

TABLE 4

| | | | | | Sieve | |
|---|---|---|---|---|---|---|
| | | | | | through | |
| | HPS | PAAm | Granule | | fraction | |
| | % by | % by | moisture | Bulk | <0.063 mm | Comparative/ |
| Ex. | wt. | wt. | content | density | % by wt. | Inventive |
| 11 | 1 | 0.3 | 72 | 254 | 64 | I |
| 12 | 2 | 0.3 | 73 | 303 | 73 | I |

### Examples 13 to 14

In a 300 1 ploughshare mixer from Lödige, 37 kg of a moist methylhydroxypropyl cellulose (solids content 40% by weight, 13 000 mPas, DS (M) 1.9 and MS (HP) 1.0) are mixed intensely at 50-30° C. with starch ether powder (hydroxypropyl starch, MS (HP) 0.5, Brookfield viscosity 5% strength by weight in water: 1 200 mPas at 25° C., spindle 4 at 100 rpm, amount used based on dry MHPC: see Table 4) and sprayed with water so as to give the moisture content (based on total mass) listed in Table 4 in the resulting granules (granule moisture content). The granules are subsequently comminuted and simultaneously dried in the combined milling/drying apparatus described above, but this time operating at a rotor speed of 2 000 rpm and additionally with the insertion in the gas flow, between bag filter and heat exchanger, of a scrubber, so that the water vapour is deposited in the transport gas. At the same time 20 m³ nitrogen/h are metered into the circuit. The transport gas used in this case, then, is nitrogen, which is heated in the heat. exchanger to 155-175° C. The volume of gas circulated and the temperature downstream of the mill correspond to the values indicated above. The throughput of dried MHPC was approximately 15 kg/h.

TABLE 5

| | | Granule | | Sieve through | |
|---|---|---|---|---|---|
| | HPS | moisture | Bulk | fraction | |
| | % by | content | density | <0.063 mm | Comparative/ |
| Example | wt. | % by wt. | g/l | % by wt. | inventive |
| 13 | 0 | 65.4 | 257 | 12 | C |
| 14 | 2.0 | 65.3 | 353 | 33 | I |

Under otherwise comparable conditions the process of the invention (Example 14), even when using MHPC and drying in a stream of nitrogen, gives a product having a markedly higher bulk density and markedly higher fine fraction in the sieve line as compared with the comparative Example C13 (without hydroxypropyl starch additive).

### Examples 15 to 18

A methylhydroxyethyl cellulose in powder form (moisture content: 2.3% by weight, 22 000 mPas, DS (M) 1.8 and MS (HE) 0.1) in the form of a dry powder was mixed intensely with dry starch ether powder. The starch ether used was the same as in Examples 3 and 4. Table 6 shows the bulk density as a function of the amount employed.

TABLE 6

| | HPS | Bulk | Comparative/ |
|---|---|---|---|
| Example | % by wt. | density g/l | Inventive |
| 15 | 0 | 200 | C |
| 16 | 2.0 | 208 | C |
| 17 | 5.0 | 215 | C |
| 18 | 10.0 | 223 | C |

The dry blending of pulverulent methylhydroxyethyl cellulose with starch ether powder leads only to a slight increase in the bulk density. Accordingly, the addition of 2% by weight of starch ether as additive here leads only to a bulk density increase of 8 g/l. In the process of the invention according to Examples 3 or 4, on the other hand, the addition of 2% by weight of starch ether as additive leads to a bulk density increase of more than 80 g/l.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Cellulose ether blends comprising
a) cellulose ether,
b) from 0.1 to 10% by weight of an additive selected from the group consisting of starch, starch ether, guar, guar ether and xanthan, based on the cellulose ether in a dry form,
c) optionally from 0.05 to 1% by weight of polyacrylamide, based on the dry cellulose ether, and
d) optionally further additives,
characterized in that additive b) has been metered-in as an aqueous solution or as a powder, and polyacrylamide c) has been metered-in as an aqueous solution to form a water-moist cellulose ether having a moisture content in the range from 25% to 75% by weight, based on the weight of the moist cellulose ether, with mixing and optionally with further addition of water.

2. Cellulose ether blends according to claim 1, characterized in that the cellulose ether is methyl cellulose or methylhydroxyalkyl cellulose.

3. Cellulose ether blends according to claim 1, characterized in that the additive b) has been metered in as a powder.

4. Cellulose ether blends according to claim 1, characterized in that the polyacrylamide c) is an anionic polyacrylamide having a sodium acrylate content of less than 20% by weight and a viscosity of less than 1 000 mPas.

5. Cellulose ether blends according to claim 1, characterized in that a starch ether selected from the group consisting of hydroxyalkyl starch, alkylhydroxyalkyl starch and carboxymethylhydroxyalkyl starch is used as additive b).

6. Process for producing cellulose ether blends of increased bulk density, comprising metering in a cellulose ether with mixing:
a) from 0.1 to 10% by weight of an additive selected from starch, starch ether, guar, guar ether or xanthan is metered into a water-moist cellulose ether having a moisture content in the range from 25 to 75% by weight based on the total weight of the blend, the percentages by weight being based on a dry form of the cellulose ether, in the form of an aqueous solution or in the form of a powder,
b) optionally, ,from 0.01 to 1% by weight of polyacrylamide, in the form of an aqueous solution, the percentages by weight being based on the dry cellulose ether, and
c) optionally, further additives
and, optionally, further adding water, and subsequently milling and drying the blend.

7. Process according to claim 6, characterized in that the milling and drying are carried out in one step as combined milling/drying.

8. Process according to claim 6, characterized in that the further addition of water is made until the granule moisture content of the blend is from 45 to 80% by weight, based on the total weight of the blend.

9. A process for preparing construction material system comprising adding therein cellulose ether blends according to claim 1.

10. The process according to claim 9, characterized in that the construction material systems are tile adhesives, cement compositions or plaster compositions, trowelling compositions or cementitous construction material mixtures suitable for extrusion.
